(19) United States
(12) Patent Application Publication
(10) Pub. No.: US 2015/0179037 A1
(43) Pub. Date: Jun. 25, 2015

(54) USING DATA FUSION TO ELECTRONICALLY DETECT LIQUID IN MOBILE DEVICES

(71) Applicant: Cellco Partnership d/b/a Verizon Wireless, Basking Ridge, NJ (US)

(72) Inventors: Xin Ren, Edison, NJ (US); Yuk Lun Li, Morganville, NJ (US); Jeremy Nacer, Morris Plains, NJ (US)

(73) Assignee: Cellco Partnership d/b/a Verizon Wireless, Basking Ridge, NJ (US)

(21) Appl. No.: 14/138,741

(22) Filed: Dec. 23, 2013

(51) Int. Cl. G08B 19/00; G01L 7/18

(52) U.S. Cl. CPC G08B 19/00; G01L 7/18

(57) ABSTRACT

Liquid ingress event detection methods and detectors are provided. Temperature and moisture data are synchronously collected from at least one sensor unit coupled to an electronic device susceptible to liquid damage. A rate of change of each of the temperature data and the moisture data are determined, to form respective temperature change rate data and moisture change rate data. Each of the temperature change rate data and the moisture change rate data are compared to at least one predetermined liquid ingress condition. A liquid ingress event is identified when at least one of the temperature change rate data or the moisture change rate data matches the predetermined liquid ingress condition. An indication of the identified liquid ingress event is stored.

### BACKGROUND

Liquid ingress is a problem for many electronic device companies. A significant cost may be incurred for repair and replacement of electronic devices that have been subject to liquid ingression damage. Traditionally, in some electronic devices, Liquid Damage Indicator (LDI) stickers (or tape) are strategically placed in one or more locations inside the electronic device (such as under the battery, on a circuit board, near audio ports, near Universal Serial Bus (USB) ports, etc.). LDI stickers are constructed with a chemically-coated paper backing, which changes color when in contact with water or other liquids. Thus, a LDI sticker indicates (e.g., by changing its color) that the electronic device is liquid damaged (i.e., from water and/or other liquids). The liquid damage information is important in troubleshooting an electronic device (e.g., when a customer attempts to return the electronic device or request repairs) and determining whether the electronic device is covered by the manufacturer's or service provider's warranty. In some cases, the electronic device may not be capable of being powered on when the electronic device is in need of troubleshooting.

Liquid damage information can be placed on a back or side cover of the electronic device. However, this solution is not typically implemented as the LDI sticker is not aesthetically pleasing and the LDI sticker would have to be resistant to wear and tear to which portable electronic devices are typically exposed (e.g., scratching by keys, dropping on pavement, etc.).

LDI stickers can be falsely triggered (i.e., to change color) under high moisture conditions (e.g., bathrooms, poolside). It is also easy for end users to open the electronic device and replace triggered LDI stickers with new stickers, thus, hiding the real cause of damage to the electronic device. To prevent tampering with the electronic device, many electronic devices (e.g., smartphones or tablet computers) on the market today do not have compartments (such as a battery compartment) or a cover that can be opened easily, and opening a compartment/cover can, in some cases, void the manufacturer's warranty on the electronic device. In addition, some LDI stickers may not be visible or accessible by customer service personnel (such as LDI stickers attached to a circuit board). Accordingly, it may be difficult for customer service personnel to inspect the LDI stickers and to determine the root cause of the device return, as well as to enforce the company's policy on water damaged devices.

Nano material-based water repellant coatings are also being developed. These are ultrathin polymer coatings that lowers an object's surface energy, causing liquid to form beads upon contact and roll off without being absorbed. Nano coatings may render LDI stickers essentially useless on such devices, whether or not device manufacturers choose to cover them with the same water repellent coating.

As the foregoing illustrates, a new approach for liquid ingress event detection may be desirable.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a functional block diagram of an example of an electronic device configured to detect and store liquid ingress events.

FIG. 2 is a functional block diagram of an example of a liquid ingress detector of the electronic device shown in FIG. 1

FIGS. 3A and 3B are partial cross-sectional view diagrams of electronic device examples, illustrating collection of local relative humidity and temperature data by a liquid ingress sensor unit to detect liquid ingress events.

FIG. 4 is an electric power flow diagram of the example electronic device configured to store liquid ingress events.

FIG. 5 is a flow chart example of a process for detecting and storing liquid ingress events in an electronic device.

FIG. 6A is graph of an example of temperature and relative humidity for an ambient environment external to the electronic device as a function of time illustrating differences between ambient events and liquid ingress events.

FIG. 6B is a graph of an example of temperature and relative humidity for a local environment of the electronic device as a function of time illustrating differences between ambient events and liquid ingress events.

FIG. 6C is a graph of an example of a temperature change rate and a relative humidity change rate for the local environment of the electronic device as a function of time illustrating differences between ambient events and liquid ingress events.

### DETAILED DESCRIPTION OF EXAMPLES

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The various techniques and approaches disclosed herein relate to detecting and storing liquid ingress events in electronic devices. The liquid ingress detector examples use multiple sensor elements and data fusion processing to detect liquid ingress events. In general, data fusion is the process of integration of multiple data and knowledge representing the same real-world object into a consistent, accurate, and useful representation. In an example, data from plural different sensors (such as moisture and temperature) are combined and analyzed to detect liquid ingress events. The combined data (of plural sensors) may yield better results (i.e., more accurate results, more complete results) than when the data from each sensor is used individually. By using data fusion, liquid ingress events can be distinguished from high moisture conditions. The data about detected liquid ingress events can also be used in conjunction with LDI stickers. In an example, data about detected liquid ingress events is stored in non-volatile memory, and can be retrieved at a later time. Accordingly, the stored liquid ingress events data can be used to accurately determine a liquid damage history (while reducing false positive detection of high moisture conditions), even if any LDI stickers are tampered with or are not easily accessible. The stored data about liquid ingress events may be readable by customer service personnel (such as via a Near Field Communication (NFC) reader or via a network).

In an example, temperature and moisture data (such as relative humidity data) are synchronously collected from a sensor unit that is coupled to an electronic device. The electronic device may be susceptible to liquid damage. A rate of change of each of the temperature data and the moisture data is determined, to form temperature change rate (CR) data and moisture CR data. Each of the temperature CR data and moisture CR data is compared to at least one predetermined liquid ingress condition, to reduce detection of false liquid ingress events. The predetermined liquid ingress condition may include an amplitude threshold (such as temperature threshold, a relative humidity threshold) and/or a duration of a potential liquid ingress event. Multiple threshold values/duration values may be selected to reduce false detection of high moisture conditions (which do not represent actual liquid ingress events). A liquid ingress event is identified when at least one of the temperature CR and the moisture CR matches the at least one predetermined liquid ingress condition. An indication of the identified liquid is then stored, such as in non-volatile memory.

In one example, data from one or more additional sensors (such as additional temperature sensors and/or pressure sensors) are compared against the predetermined condition(s) to identify liquid ingress events. In another example, input from one or more additional sensors (such as accelerometers or pressure sensors to detect a free-fall condition or other inertial sensors to detect device movement) is used as a trigger event to initiate collection of sensor data and detection of a potential liquid ingress event.

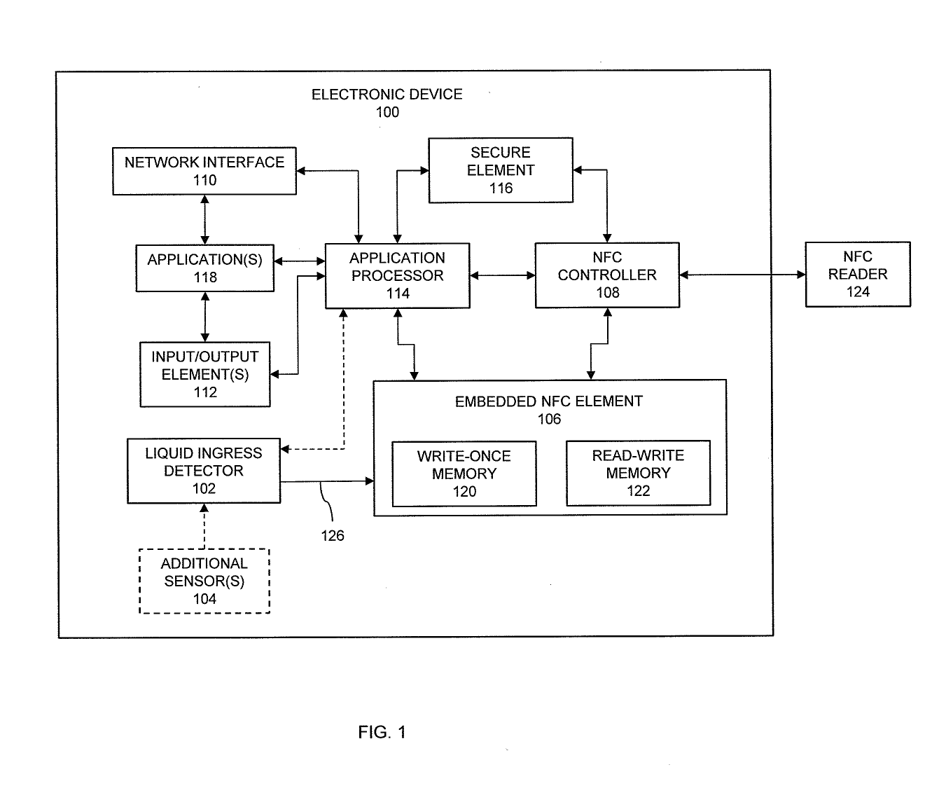

The subject technology, in some implementations, is directed to detecting liquid ingress events in electronic devices and storing indications of liquid ingress events in a form that is accessible when the electronic device is powered off. Reference now is made in detail to the examples illustrated in the accompanying drawings and discussed below. FIG. 1 is a data flow diagram of an example of an electronic device 100 configured to detect and store information responsive to liquid ingress events. The electronic device 100 can correspond to any electronic device, for example, a laptop computer, a desktop computer, a mobile phone, a tablet computer, a personal digital assistant (PDA), a digital music player, a video game controller or console, a portable video game, a television with one or more processors embedded therein or coupled thereto, etc. The electronic device 100 can be a mobile device.

As shown, the electronic device 100 in this example includes a liquid ingress detector 102, possibly one or more optional additional sensors 104, an embedded NFC element 106, an NFC controller 108, a network interface 110, input/output element(s) 112, an application processor 114, a secure element 116 and application(s) 118. The electronic device 100 is configured to communicate with a NFC reader 124 external to the electronic device 100. The electronic device 100 is also configured to communicate with a remote device (such as a call center) via network interface 110. Each of these elements are described in detail further below.

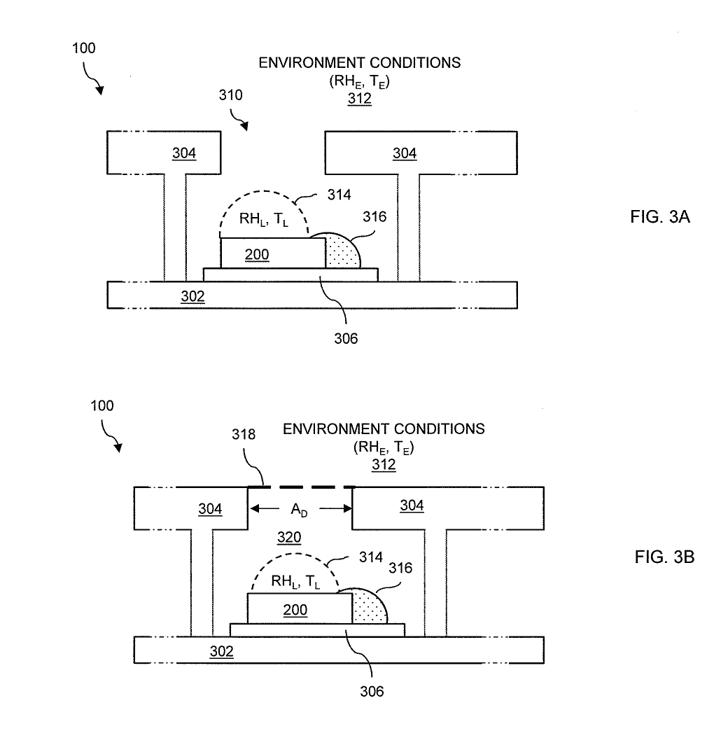

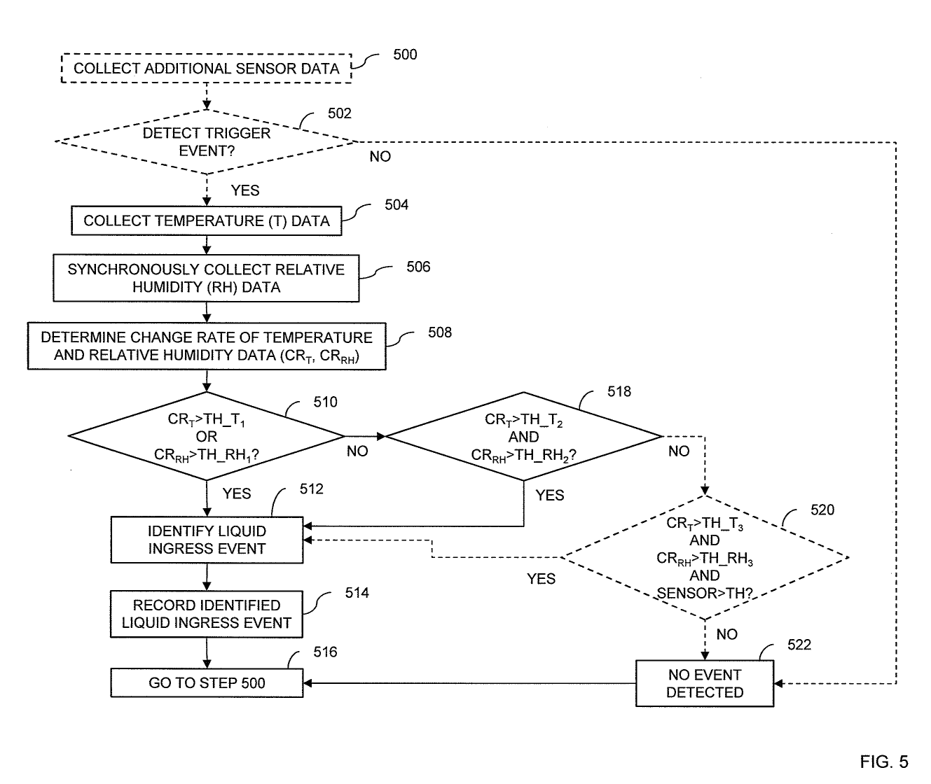

The liquid ingress detector 102 is configured to synchronously collect temperature data and relative humidity data from at least one sensor unit (such as the sensor unit 200 shown in FIG. 3A) coupled to the electronic device 100. In an example, the temperature data and relative humidity data is collected synchronously (i.e., at the same instant in time). Thus, the temperature and relative humidity conditions, at the same instant in time may be compared to identify liquid ingress events. Examples of the comparison of both conditions is described further below with respect to FIG. 5. As described further below with respect to FIGS. 3A and 3B, the sensor unit 200 collects the temperature and relative humidity data in a specified physical position in the electronic device 100. For example, the sensor unit may be positioned adjacent to the primary battery of the electronic device 100 in the primary battery compartment. In some examples, the electronic device 100 can have multiple sensor units at different positions of the electronic device 100, and different information can be stored locally at the electronic device 100 and/or transmitted via the network to the manufacturer or the service provider based on which of the sensor units indicate a liquid ingress event.

Liquid ingress detector 102 is also configured to determine a rate of change of each of the temperature data and the relative humidity data, to respectively form temperature change rate data and relative humidity change rate data. The liquid ingress detector 102 compares the temperature change rate data and the relative humidity change rate data to at least one predetermined liquid ingress condition (such as an amplitude threshold or an event duration), and identifies a liquid ingress event when at least one of the temperature change rate data or the relative humidity change rate data matches the predetermined liquid ingress condition(s). The liquid ingress detector 102 provides a liquid ingress indication 126 indicating the identified liquid ingress event to the embedded NFC element 106.

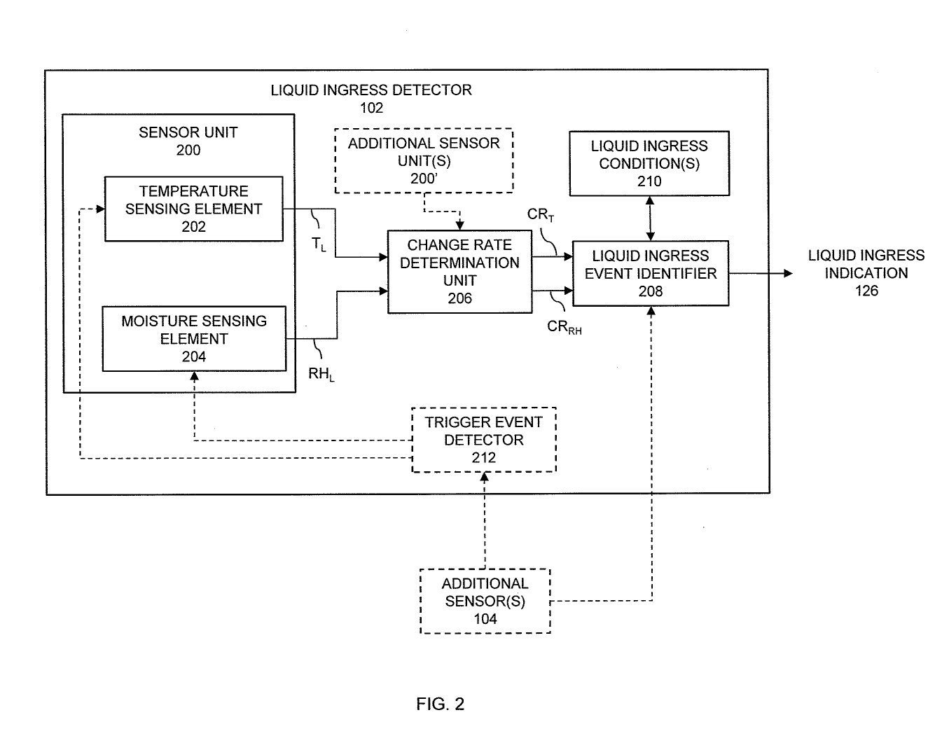

In some examples, the liquid ingress detector 102 is configured to control all liquid ingress event detection processing. In other examples, the liquid ingress detector 102 is coupled to the application processor 114 and one or more functions of the liquid ingress detector 102 are executed by the application processor 114. The liquid ingress detector 102 is described further below with respect to FIG. 2.

Electronic device 100 may include one or more optional additional sensor(s) 104. Additional sensor(s) 104 may include, without being limited to at least one of temperature sensors, barometric pressure sensors or inertial sensors (e.g., accelerometers, gyroscopes, magnetometers). Data from the additional sensor(s) 104 may be used by liquid ingress detector 102, in conjunction with the relative humidity and temperature data (collected by the liquid ingress detector 102) for detecting liquid ingress events.

The embedded NFC element 106 stores the information that is accessible when the electronic device 100 is powered off. The embedded NFC element 106 may require relatively little power (e.g., a passive tag that is able to draw enough radiated power from a remote source) and/or may have its own power source independent of the primary battery of the electronic device 100. The embedded NFC element 106 can be implemented as any short-range radio communication tag or embedded short-range radio communication element. In some examples, the embedded NFC element 106 is implemented as a secure element or as a component of the secure element 116. However, if the embedded NFC element 106 is a secure element or a part of a secure element, the embedded NFC element 106 can be powered through a NFC chip or a dedicated NFC battery, rather than the default power source (e.g., primary battery) for the electronic device 100. Alternatively, as illustrated in FIG. 1, the embedded NFC element 140 can be separate and distinct from the secure element 116.

In some examples, the embedded NFC element 106 includes write-once memory 120 and read-write memory 122. The write-once memory 120 can store, for example, a device identification number for the electronic device 100, a battery identification number for the primary battery of the electronic device 100, or an identification of network or radio access capabilities (e.g., WiFi, Bluetooth®, 3G, etc.) of the electronic device 100. The read-write memory 122 can include a usage log of the electronic device 100 so that a reason for failure of the electronic device 100 can be determined in the event of a failure.

According to some implementations, the embedded NFC element 106 stores a liquid ingress event indicator based on the indication 126 received from liquid ingress detector 102. The liquid ingress event indicator can be stored in the write-once memory 120. In one example, the liquid ingress event indicator could initially be set to 0, FALSE, or BLANK, and permanently reset to 1, TRUE, or NON-BLANK in an event that liquid ingress event detector 102 in the electronic device 100 detects a liquid ingress event at a specified physical position in the electronic device 100 (e.g., the first time the liquid ingress event detector 102 detects water).

In some implementations, each time a liquid ingress event is detected (and indicated to embedded NFC element 106 by indication 126) the liquid ingress event is written in read-write memory 122, to form a liquid damage history of electronic device 100. Each stored liquid ingress event may include at least one of a date, a time, a duration or a severity of the liquid ingress event. For example, there may be different levels of severity which may be indicated by comparison of the temperature change rate data and the relative humidity change rate data to multiple predetermined liquid ingress conditions, by data from additional sensor(s) 104 and/or by liquid ingress events identified at multiple sensor units. As one example, different predetermined liquid ingress conditions may be associated with different levels of liquid ingress severity. As another example, if a liquid ingress event is detected by one sensor unit, this may indicate a local event. If the liquid ingress event is detected by multiple sensor units at different locations on the electronic device (or indicated by additional sensor(s) 104), this may indicate a severe event. In another example, the liquid damage history stored in read-write memory 122 may merely store a number of times that a liquid ingress event is detected.

According to some implementations, the embedded NFC element 106 can store one or more of the following data items: device specific identification information (e.g., International Mobile Station Equipment Identity (IMEI), Stock-Keeping Unit (SKU), serial number, part number, Federal Communications Commission Identifier (FCC ID), manufacture location, device model number, hardware version number, software version number, device radio frequency (RF) technology/capability information, device chipset information (application/modem processor), device WIFI/Bluetooth® media access control (MAC) address, etc.); battery specific information (e.g., battery cell model number, battery pack model number, battery cell manufacture and location, battery pack manufacture and location, battery pack serial number, battery norminal voltage, battery capacity, battery chemistry information, battery recycle method, etc.); device certification information (e.g., certification icons such as Conformité Européenne (CE), Underwriters Laboratories® (UL), WIFI, Bluetooth® (BT), Global Certification Forum® (GCF), etc.); and/or device quality information (e.g., device panic/failure statistic information, device over temperature statistic information, device network signal statistic information, LDI, device energy usage information, battery cycle life information, etc.).

In some examples, the embedded NFC element 106 includes authenticated or encrypted data that in one implementation can only be decrypted by a specialized NFC reader 124. The specialized NFC reader 124 may be a NFC reader of a service provider located at a store of the service provider for use by employees of the service provider. As a result, only authorized devices (and thus people) can read information stored in the write-once memory 120 and/or the read-write memory 122 of the embedded NFC element 106.

The network interface 110 is configured to allow the electronic device to transmit and receive data via one or more networks, for example, the Internet, a wired network, a wireless network, a local area network (LAN), a wide area network (WAN), a cellular network, a WiFi network, etc. The network interface 110 may include one or more network interface cards (NICs). In some examples, the network interface 110 includes a wireless transceiver configured to enable wireless data communication via the one or more networks.

The input/output element(s) 112 are configured to allow a user of the electronic device 100 to interface with the electronic device 100. The input/output element(s) 112 may include one or more of a keyboard, a mouse, a touch screen, a non-touch display device, a telephone dial pad, a television remote control, etc. The input/output element(s) 112 can be internal to the electronic device 100 (e.g., a touch screen can be a component of a mobile phone) or external to the electronic device 100 (e.g., a laptop computer can be connected to an external mouse via a universal serial bus (USB) port or a Bluetooth® radio connection).

The application processor 114 is configured to control operation of the electronic device 100 or to execute application(s) 118 stored at the electronic device 100. While a single application processor 114 is illustrated, the application processor 114 can be replaced with some other processing hardware, for example, one or more of a central processing unit (CPU) including one or multiple processors, a graphics processing unit (GPU) including one or multiple processors, a video processing unit including one or multiple processors, or any other processing unit(s). The application processor 114 can be a host processor.

The application(s) 118 include applications stored in a memory of the electronic device 100. The application(s) 118 can include any software application(s), for example, a web browser, a word processing application, a mobile payment application, a NFC code reader application for viewing webpage(s) or other information associated with a NFC code, etc. The application(s) 118 can include mobile phone, digital music player, or tablet computer application(s). The application(s) 118 can be stored in a memory of the electronic device 100. The memory can correspond to a cache unit, a storage unit, a long-term memory, a short-term memory, etc.

The NFC controller 108 can include or be coupled with an antenna (not shown) for transmitting and/or receiving NFC communication(s) to and/or from NFC reader 124 external to the electronic device 100. For example, NFC controller 108 may send detected liquid ingress events to NFC reader 124 which are stored in embedded NFC element 106. In some examples, the NFC controller 108 has a wired connection to the embedded NFC element 106 or the NFC controller 108 and the embedded NFC element 106 reside on the same circuit board. In some examples, the embedded NFC element 106 includes its own antenna and is wirelessly connected to the NFC controller 108.

The NFC controller 108 is configured to route NFC communications through various components of electronic device 100 according to a technology being used. For example, if the electronic device 100 is being used to implement a security function (such as to process a payment (e.g., to a merchant who may require credit card information to process the payment) via a payment terminal), the NFC controller 108 may route the NFC communications to the secure element 120 via the connection 138. Secure element 116 may store applications and/or credentials (e.g., financial account numbers) and provide for secure execution of applications (such as for financial transactions or mobile marketing applications (e.g., coupons and/or loyalty points).

If the electronic device 100 is being used to access an application that does not require a security function, for example, an application for viewing a publically accessible webpage associated with a passive NFC tag external to the electronic device 100, the NFC controller 108 may route the NFC communications to the application processor 114. If the NFC controller 108 is communicating with a specialized NFC reader 124 for reading data from embedded NFC element 106, the NFC controller 108 may route the communication to the embedded NFC element 108. The type of application (e.g., security, no security, or specialized NFC reader) can be specified within a message transmitted to or from the electronic device 100 using the NFC controller 108), for example, within a header or a payload of the transmitted message.

In some examples, the NFC controller 108 includes logic to become transparent upon detecting the NFC reader 124 or upon losing power from a primary battery of the electronic device 100 (e.g., when the electronic device 100 is powered off or unable to power on due to damage). As a result, the NFC reader 124 can still access the embedded NFC element 106 through the NFC controller 108 and complex operations of the NFC controller 108 (e.g., determining whether to route a communication to the secure element 116, the application processor 114, or the embedded NFC element 108) are not required. After the NFC controller 108 becomes transparent, the NFC reader 124 can read and process data from the embedded NFC element 106.

The NFC reader 124 resides externally to the electronic device 100 and communicates with the electronic device via NFC. The NFC reader 124 may have a cryptographic key and may authenticate the NFC controller 108 or the embedded NFC element 106 using the cryptographic key. Alternatively, any other authentication technique can be used. The NFC reader 124 provides a command to the NFC controller 108 informing the NFC controller 108 that communication from the NFC reader 124 should be routed directly to the embedded NFC element 106 (rather than to the secure element 116 or the application processor 114),

The subject technology is described above as being implemented with NFC radio technology. However, the subject technology may be implemented with any other short-range radio communication technology in place of NFC. For example, in some cases, NFC radio technology can be replaced with one or more of: Bluetooth® radio technology, radio frequency identifier (RFID) technology, WiFi technology, microwave technology, etc. As used herein, the phrase “short-range radio,” includes any radio for communication at distances below a threshold distance. The threshold distance can be, for example, 5 meters, 1 meter, 10 centimeters, 5 centimeters, 2 centimeters, 1 centimeter, 5 millimeters, etc.

According to some examples, the electronic device 100 operates according to a sequence upon detecting a liquid ingress event by the liquid ingress detector 102. The electronic device 100 may attempt to transmit the indication of the detected liquid ingress event over the network, for example, to the manufacturer or the service provider for the electronic device 100. For example, electronic device 100 may attempt to transmit the liquid ingress event indication if the network interface 110 and the application processor 114 are still functioning after the liquid ingress event is detected.

If the network interface 110 is not functioning or not connected to a network, the liquid ingress event indication may be stored locally, in the embedded NFC element 106 (and and not transmitted to the manufacturer or service provider). The manufacturer or service provider may use a short-range radio reader (e.g., a NFC reader 124) to determine that the liquid ingress detector indicates a liquid ingress event in the electronic device 100. Upon learning of water damage to the electronic device 100, the manufacturer or service provider can void the warranty on the electronic device 100 or refuse to allow repairs of the electronic device 100 under the warranty.

In some examples, the information transmitted over the network to indicate a liquid ingress event includes a device identifier (e.g., an International Mobile Station Equipment Identity (IMEI) number) of the electronic device 100. The information transmitted over the network to indicate the liquid ingress event can also include the content of the liquid ingress event indication of the electronic device 100 and/or information about user activity (e.g., running software programs) on the electronic device 100 at the time the liquid ingress detector 102 detected the event to guard against inadvertent transmission of the indication of the liquid ingress event. For example, the user's activity may falsely trigger the electronic device 100 to transmit an indication of a liquid ingress event over the network. By sending the content of the liquid ingress event indication as well as the user's activity, the technician can affirm whether an actual liquid ingress event occurred in the electronic device 100.

In some examples, different message(s) (e.g., message(s) containing different information and/or message(s) directed to different destination(s)) can be transmitted over the network depending on the severity of the liquid ingress event. For example, when a liquid ingress event is detected by the liquid ingress detector 102, a first message can be transmitted over the network and a diagnostic test can be conducted on the electronic device 100. A second message can be transmitted over the network based on the result of the diagnostic test and/or information regarding the result of the diagnostic test can be stored locally at the electronic device 100. The severity of the liquid ingress event can be determined by the liquid ingress detector 102, for example, based on an amount of moisture present at the water detector. In some examples, the severity of the liquid ingress event can be determined based on an amount of pressure to which the mobile device is exposed, as measured for example, by a pressure meter within the water detector, as pressure increases when a device is submerged in water.

Referring next to FIG. 2, a functional block diagram of an example of liquid ingress detector 102 is shown. The liquid ingress detector 102 includes sensor unit 200, change rate determination unit 206, liquid ingress event identifier 208 and one or more predetermined liquid ingress conditions 210. The liquid ingress detector 102 may include one or more optional additional sensor units 200′ and/or optional trigger event detector 212. Additional sensor unit(s) 200′ are the same as sensor unit 200 except that additional sensor unit(s) 200′ are positioned at different locations in electronic device 100.

The sensor unit 200 includes a temperature sensing element 202 and a moisture sensing element 204. In some implementations, the sensor unit 200 may include a humidity sensor (such as a SHTC1 humidity sensor manufactured by Sensirion®). Humidity sensors are typically used to measure ambient humidity. The raw output of a humidity sensor is the ambient relative humidity (RH), which is not in itself an indicator of liquid ingress. However this output can be processed and intelligently combined or “fused” with other complementary information to serve as an effective indication of liquid ingress.

In general, humidity sensors measure relative humidity. The relative humidity (φ) of an air-water mixture is defined as the ratio of the partial pressure of water vapor (H₂O) (e_{w}) in the mixture to the saturated vapor pressure of water (e*_{w}) at a given temperature. Relative humidity is typically expressed as a percentage and is determined using eq. (1) as:

$$φ = \frac{{e}_{w}}{{e}_{w}^{*}} \times 100 \% . \qquad ( 1 )$$

Because the relative humidity is dependent on temperature, sensor unit 200 detects the relative humidity of its immediate (local) environment by measuring both the temperature (via temperature sensing element 202) and the moisture level (via moisture sensing element 204) around it. The temperature sensing element 202 collects local temperature data (T_{L}) and the moisture sensing element 204 collects local relative humidity (RH_{L}) data (also referred to herein as moisture data).

Referring to FIGS. 3A and 3B partial cross-sectional view diagrams of the electronic device 100 are shown which illustrate a position of the sensor unit 200 in the electronic device 100. In general, the sensor unit 200 is coupled to a circuit board 306 within the device housing 304. The circuit board 306 is disposed on a substrate 302 of the electronic device 100. Sensor unit 200 may be positioned, for example, near the primary battery (not shown) of electronic device 100. The sensor unit 200 measures local conditions 314 (i.e., RH_{L} and T_{L}) proximate to the sensor unit 200. FIGS. 3A and 3B illustrate an example where liquid 316 has entered the electronic device 100.

The device housing 304 includes an aperture 310, to couple sensor unit 200 to the environment conditions 312 (i.e., the environment RH (RH_{E}) and the environment T (T_{E})) that are external to electronic device 100. Sensor unit 200 is connected to the environment conditions 312 (via aperture 310) in order for sensor unit 200 to quickly and accurately reflect the environment conditions 312 (so that that the local conditions 314 correspond to the environment conditions 312). In FIG. 3B, optional filter membrane 318 is disposed over aperture 310, to protect sensor unit 200 from various contaminants (e.g., dust and dirt).

Regardless of the design and placement of the sensor unit 200 in the electronic device 100, sensor unit 200 may not respond immediately to changes in environment conditions 312. The diameter (A_{D}) of the aperture 310 (i.e., the size of the opening to the environment conditions 312) and the “dead volume” 320 (i.e., the volume around the sensor unit 200 that is separated from the environment conditions 312), are important factors affecting how fast location conditions 314 can respond to environment conditions 312. The amount of time for the sensor unit 200 to equilibrate with new (i.e., changing) environmental conditions 312 is called a response time. Typical response times include, for example, about 5-10 seconds for relative humidity, and about 5-30 seconds for temperature depending on the heat capacity of the sensor substrate and the thermal resistance to the sensor substrate.

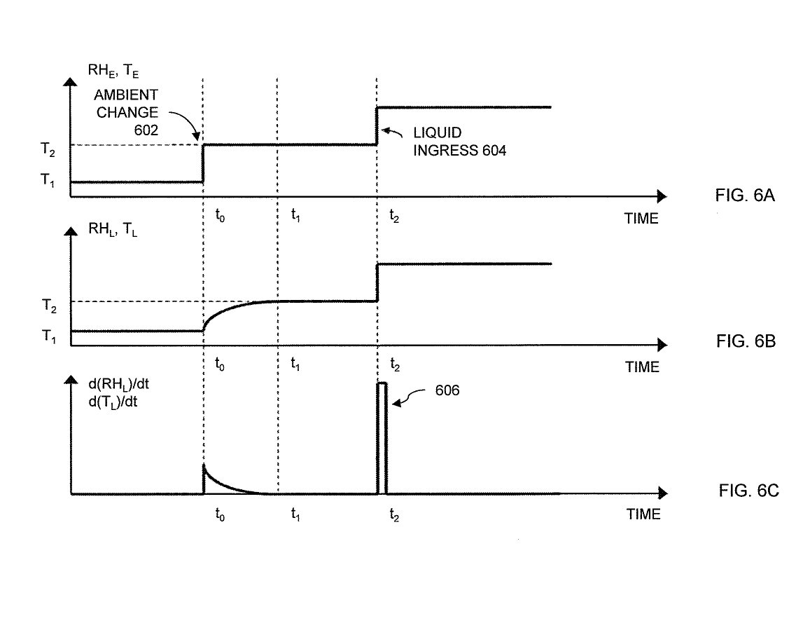

Referring back to FIG. 2, liquid ingress detector 102 may collect data from sensor unit (as well as optional additional sensor unit(s) 200′) and provide corresponding local temperature (T_{L}) data and local relative humidity (RH_{L}) data to change rate determination unit 206. The change rate determination unit 206 is configured to determine a rate of change (also referred to herein as change rate (CR)) of the local temperature data (to form CR_{T}) and to determine a rate of change of the local relative humidity data (to form CR_{T}). The change rate determination unit is described further below with respect to FIGS. 6A-6C.

FIG. 6A is an example graph of temperature (T_{E}) and relative humidity (RH_{E}) for an ambient environment external to the electronic device (such as environment conditions 312 shown in FIG. 3A) as a function of time illustrating differences between ambient events 602 and liquid ingress events 604. FIG. 6B is an example graph of temperature (T_{L}) and relative humidity (RH_{L}) for a local environment of the electronic device (such as local conditions 314 shown in FIG. 3A) as function of time illustrating differences between ambient events 602 and liquid ingress events 604. The vertical axes in FIGS. 6A and 6B illustrate variation in temperature. It is understood that the vertical axes could just as well illustrate variation in relative humidity. FIG. 6C is an example graph of a temperature change rate (d(RH_{L})/dt) and a relative humidity change rate (d(T_{L})/dt) for the local environment of the electronic device as a function of time illustrating differences between ambient events 602 and liquid ingress events 504. In FIGS. 6A-6C, time t=t₀ indicates an onset of an ambient event 602 (i.e., an ambient change in the conditions). Time t=t₂ indicates an onset of a liquid ingress event 604.

Liquid ingress may be characterized by either of the following two events: a rapid change (increase or decrease) of temperature or a rapid increase of RH to 100%.

Firstly, with very high likelihood, in a liquid ingress event 604, the liquid 316 (FIG. 3A) (e.g., tap water, pool water, spilled coffee, etc.) that comes in contact with the sensor unit 200 will have a local temperature that is measurably different from the ambient temperature. This will cause a near instantaneous change in a local temperature measurement. In contrast, any indication by sensor unit 200 of ambient temperature change 602 will tend to be gradual, i.e. on the order of minutes or hours. Even in the rare case of a sudden ambient temperature change 602, the temperature measurement on the sensor unit 200 will lag by at least the response time of the sensor unit 200. Thus, in FIG. 6A, a sudden ambient temperature change 602 produces an instantaneous change in the environment conditions 312. In contrast, in FIG. 6B, the sudden ambient temperature change 602 produces a gradual change in the local conditions 314, with maximum response at time t=t₁.

Secondly, liquid flowing into the measuring cavity of the sensor unit 200 will trigger a near instantaneous increase in RH measurement to 100%. In contrast, when a mobile device is taken to an environment with a very high moisture condition (e.g., about 100% RH, such as a bathroom), the change in ambient RH will again be gradual and measurement on the sensor unit 200 will be subject to response time constraints.

As illustrated conceptually in FIG. 6C, the rate of change of RH_{L} or T_{L} with respect to time is very different between an ambient event 602 and a liquid ingress event 604. An example below for the rate of change is given below for the local temperature T_{L} (measured by sensor unit 200). Similar results are obtained for the local relative humidity RH_{L} (measured by sensor unit 200).

Using temperature T_{L}, with T₁, T₂ being the respective starting and ending temperatures of a step change 602 in ambient temperature, then T_{L} may be represented in eq. (2) as:

$${T}_{L} = {T}_{1} + ( {T}_{2} - {T}_{1} ) ( 1 - {e}^{- \frac{1}{τ} ( t - {t}_{0} )} ) \qquad ( 2 )$$

And the rate of change CR_{T} may be represented as a differential, shown in eq. (3) as:

$${CR}_{T} = d ( {T}_{L} ) \text{/} d t = \frac{( {T}_{2} - {T}_{1} )}{τ} {e}^{- \frac{1}{τ} ( t - {t}_{0} )} . \qquad ( 3 )$$

In eq. (3), τ is the sensor unit response time, defined as the time required by the sensor unit 200 to reach readings of about 63% of the step height. The larges differential amplitude ΔT/τ occurs at t=t₀, which gradually attenuates to 0.

In comparison, when there is a step change in temperature caused by liquid ingress event 604, a large spike 606 occurs in the differential amplitude (i.e., the change rate), which abruptly drops down to near zero. Based on this, thresholds for the initial amplitude and/or the duration of the differential amplitude 606 (i.e., where the differential amplitude is greater than 0) can be empirically set to determine a liquid ingress event.

Referring Back to FIG. 2, the change rate determination unit 206 may determine the change rate of the local temperature data (to form CR_{T}) and the rate of change of the local relative humidity data (to form CR_{RH}) by any suitable means. In some implementations, the change rate may be determined by a first order time derivative. It is contemplated that any of a number of well-known numerical methods may be used to estimate the time derivative and that a higher order time derivative may be determined in order to detect liquid ingress events. The change rate determination unit 206 provides the temperature CR (CR_{T}) and the relative humidity CR (CR_{RH}) to liquid ingress event identifier 208.

Liquid ingress event identifier 208 compares each of the temperature CR (CR_{T}) and the relative humidity CR (CR_{RH}) to one or more predetermined liquid ingress condition(s) 210 to identify liquid ingress events. As discussed above, the predetermined liquid ingress condition(s) 210 may include one or more CR amplitude thresholds (for the temperature CR and the relative humidity CR) or one or more duration thresholds (for the temperature CR and the relative humidity CR). The predetermined liquid ingress condition(s) 210 may also include one or more thresholds associated with additional sensor(s) 104.

While either temperature or relative humidity conditions could be used independently with high confidence to detect liquid ingress events, the liquid ingress event identifier 208 detects the simultaneity of both conditions, which may help to eliminate false positive liquid ingress events (such as condensation caused by high moisture conditions) and increase the detection reliability.

Complementary sensor information from additional sensor(s) 104 may also be used by liquid ingress event identifier 208 to enhance the liquid ingress event detection.

Often, there are additional temperature sensors (other than the temperature sensing element 202 in sensor unit 200) in the electronic device 100. One example includes temperature sensors embedded in some CPUs. Another example includes a temperature sensing element in a barometric pressure sensor. Still another example includes a standalone temperature sensor. When present, these additional sensor(s) 104 are typically located on the main printed circuit board (PCB) of the electronic device 100. Because of their placement, in a minor to moderate liquid ingress event, liquid may not come in contact with these sensors. On the other hand, in a massive liquid ingress event, the PCB may be severely damaged and fail, before a reliable reading can be obtained from these sensors. Despite their limitations, when available, data from these additional sensor(s) 104 can be used in conjunction with those from the sensing unit 200, to ascertain the occurrence of liquid ingress events, and to help determine the extent of liquid damage. Examples of predetermined liquid ingress conditions 210 and the use of additional sensor(s) 104 are shown in FIG. 5, described further below. If liquid ingress event identifier 208 identifies a liquid ingress event, liquid ingress event identifier 208 generates and sends the liquid ingress indication 126 to embedded NFC element 106 (FIG. 1).

According to some implementations, liquid ingress detector 102 includes trigger event detector 212. Trigger event detector 212 controls collection of data from sensor unit 200 based on data received from additional sensor(s) 104.

For example, accelerometers can detect free-fall condition, which typically precedes a liquid ingress event. In general, inertial sensors can detect device movement. Trigger event detector 212 can activate the sensor unit 200 when the electronic device 100 moves. Otherwise, the sensor unit 200 can stay in an idle/low power mode (i.e., when the electronic device 100 is stationary). In some examples, different thresholds may be set for different types of device movement, and data from among the additional sensor(s) 104 may be compared to the different thresholds. For example, a first threshold may be used to identify whether there is any movement of the electronic device 100. A second (e.g., higher) threshold may indicate rapid movement of the electronic device 100, such as the electronic device 100 approaching a free-fall condition. In some examples, general movement of the electronic device 100 (e.g., based on the first threshold) may cause further collection of additional sensor data to identify whether the electronic device 100 is about to be dropped (e.g., based on the second threshold). Trigger event detector 212 can active the sensor unit 200 when the additional sensor data indicates that the second threshold is reached.

In some examples, trigger event detector 212 adjusts a duty cycle of sensor unit 200 (i.e., how often sensor unit 200 takes measurements), based on data from additional sensor(s) 104 such as inertial sensors. Adjustment of the duty cycle may be used to control power consumption of the sensing unit 200.

Complementary sensor information from additional sensor(s) 104 can be modeled for typical liquid ingress events and then included in predetermined liquid ingress condition(s) 210. When the sensor data matches the predetermined liquid ingress condition(s) 210 for liquid ingress events, the conditions experienced by the sensor unit 200 can be logged and stored in non-volatile memory such as in embedded NFC element 106 (FIG. 1). This gives authorized personnel the ability to retrieve the electronic device's conditions and last known movements before liquid ingress, confirming a liquid ingress event.

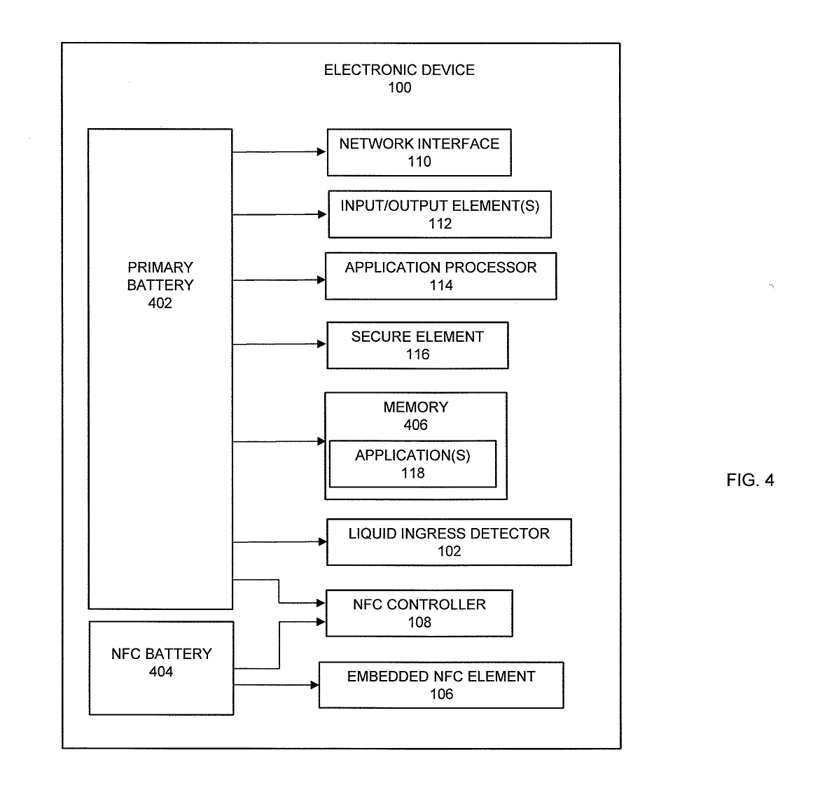

FIG. 4 is an electric power flow diagram of the example electronic device 100 configured to detect and store liquid ingress events. As shown, the electronic device 100 includes the liquid ingress detector 102, the embedded NFC element 106, the NFC controller 108, the network interface 110, the input/output element(s) 112, the application processor 114 and the secure element 116 described in conjunction with FIG. 1. The application(s) 118 reside within a memory 406. The memory 406 can include one or more of a cache unit, a storage unit, an internal memory, an external memory, a long-term memory, or a short-term memory. The electronic device 100 also includes a primary battery 402 and a NFC battery 404.

The primary battery 402 can correspond to a battery primarily responsible for powering the electronic device 100, for example, when the electronic device 100 is in an “on” state. The primary battery 402 can reside in a battery compartment of the electronic device 100, for example, at the bottom of a laptop computer or at the back of a mobile phone or tablet computer. In some implementations, for instance, in a desktop computer, the primary battery 402 may be replaced with a primary power source that plugs into a wall power outlet. As shown in FIG. 4, the primary battery 402 powers the liquid ingress detector 102, the NFC controller 108, the network interface 110, the input/output element(s) 112, the application processor 114, the secure element 116 and the memory 406.

The NFC battery 404 can reside on a NFC chip or in another location. In some examples, the NFC chip can also include the NFC controller 108 and/or the embedded NFC element 106. The NFC battery 404 can be smaller than the primary battery 402, but can have a longer battery life, as the NFC battery 404 may, in some examples, provide a relatively small amount of power to the embedded NFC element 106 and the NFC controller 108. In some implementations, the NFC battery 404 can be replaced with other batteries. The NFC battery 404 can be more damage-resistant than the primary battery 402. For example, the NFC battery 404 may be water-resistant or able to withstand extreme temperature conditions. In some examples, the NFC battery 404 is protected by a shield that insulates the NFC battery 404 from water or extreme temperature conditions. In some examples, the NFC battery 404 is built into the NFC chip and is not removable from the electronic device 100. In some examples, the NFC battery 404 is removable from the electronic device 100. In some examples, the NFC controller 108 can be operated in a passive mode. In the passive mode, power is drawn from a magnetic field of the NFC reader 124 (FIG. 1) to operate the NFC controller 108. If liquid ingress event data is stored in the write-once memory 120 (FIG. 1) (coupled to the NFC controller 108), the NFC reader 124 may still read the liquid ingress event using the passive mode (even if the NFC battery 404 is drained and/or damaged). The passive mode may be useful, for example, when the electronic device 100 is dead and the primary and NFC batteries 402, 404 are drained but the NFC controller 108 and the write-once memory 120 are still functional.

As shown, the NFC controller 108 is powered by both the primary battery 402 and the NFC battery 404. In some examples, the NFC controller 108 includes logic that determines the battery source (e.g., the primary battery 402 or the NFC battery 404) and changes the functionality of the NFC controller 108 accordingly.

When the electronic device 100 is turned “on,” the NFC controller 108 can be powered by the primary battery 402 and function to transmit NFC communication(s) from the NFC reader 124 (FIG. 1) to any of the secure element 116, the application processor 114, or the embedded NFC element 106 depending on the type of NFC communication(s) from the NFC reader 124. In some examples, the NFC controller 108 is wired to receive power from both the primary battery 402 and the NFC battery 404. The NFC controller includes logic to determine whether the primary battery 402 is providing power. If so, the NFC controller includes logic to receive power from the primary battery 402. If not, the NFC controller includes logic to receive power from the NFC battery 404.

When the electronic device 100 is turned “off,” or the primary battery 402 is disabled, e.g., due to damage of the primary battery 402, the NFC controller 108 is powered by the NFC battery 404 and not by the primary battery 402. When the NFC controller 108 is being powered by the NFC battery 404, the NFC controller 108 can function as a pass-through device that routes all NFC communication(s) received (e.g., from the NFC reader 124) at the NFC controller 108 to the embedded NFC element 106 (which is also powered by the NFC battery 404). When powered by the NFC battery 404, the NFC controller 108 may require less power as the NFC controller 108 functions as a pass-through device and does not need to implement logic to route communication(s) based on the type of communication(s).

FIG. 5 is a flow chart of an example method for detecting and storing liquid ingress events in an electronic device (such as the electronic device 100 shown in FIG. 1). Aspects of the example method shown in FIG. 5 may be performed, for example, by the liquid ingress detector 102 shown in FIG. 2. It is understood that FIG. 5 represents an example of identification of liquid ingress events, and that other combinations of liquid ingress conditions may also be used to detect liquid ingress events.

At optional step 500, additional sensor data is collected, for example, by one or more additional sensors 104 (such as inertial sensor data). At optional step 502, it is determined, for example, by trigger event detector 212, whether a trigger event is detected. For example, trigger event detector 212 may detect movement of electronic device 100 (FIG. 1) based on inertial data from additional sensor(s) 104. If, at optional step 502, a trigger event is detected, step 502 proceeds to step 504. If, at optional step 502, a trigger event is not detected, step 502 proceeds to step 522.

At step 504, temperature data is collected. At step 506, relative humidity data is collected. Although steps 504 and 506 are illustrated separately, the relative humidity data is collected synchronously with the temperature data. The temperature and relative humidity data is collected by at least one sensor unit 200 at a defined position in electronic device 100. In some examples, the temperature and relative humidity data can be collected from multiple sensor units (e.g., the sensor unit 200 and additional sensor unit(s) 200′) at different defined positions in the electronic device 100. In some implementations, steps 504 and 506 occur after a trigger event is detected (step 502). In some implementations, steps 504 and 506 occur periodically, at a predetermined duty cycle. In some examples, the duty cycle may be selected based on the additional sensor data (step 500).

Step 506 proceeds to step 508. At step 508, a change rate of the temperature data (CR_{T}) and a change rate of the relative humidity data (CR_{RT}) are determined, for example, by change rate determination unit 206, responsive to the collected temperature and humidity data (steps 504 and 506).

At step 510, it is determined whether the temperature CR is greater than a first temperature threshold (TH_T₁) (i.e., CR_{T}>TH_T₁) or the relative humidity is greater than a first relative humidity threshold (TH_RH₁) (i.e., CR_{RH}>TH_RH₁). The thresholds TH_T₁ and TH_RH₁ represent predetermined liquid ingress conditions 210. Although the thresholds TH_T₁ and TH_RH₁ illustrate amplitude thresholds, one or more of the threshold may include event duration thresholds. Step 510 may be performed, for example, by liquid ingress event identifier 208.

If it is determined, at step 510, that at least one of the temperature CR or the relative humidity CR satisfies the conditions of step 510 (such as by liquid ingress event identifier 208), step 510 proceeds to step 512. At step 512, a liquid ingress event is identified, responsive to determining that the liquid ingress conditions are matched. For example, the liquid ingress event identifier 208 identifies the liquid ingress event and generates the liquid ingress indication 126.

At step 514, the identified liquid ingress event is recorded. For example, responsive to the liquid ingress indication 126, the liquid ingress event is recorded at embedded NFC element 106 (FIG. 1). Step 516 proceeds to step 516.

If it is determined, at step 510, that neither the temperature CR nor the relative humidity CR satisfies the conditions of step 510 (such as by liquid ingress event identifier 208), step 510 proceeds to step 518.

At step 518, it is determined whether the temperature CR is greater than a second temperature threshold (TH_T₂) (i.e., CR_{T}>TH_T₂) and the relative humidity is greater than a second relative humidity threshold (TH_RH₂) (i.e., CR_{RH}>TH_RH₂). The thresholds TH_T₂ and TH_RH₂ represent predetermined liquid ingress conditions 210. Although the thresholds TH_T₂ and TH_RH₂ illustrate amplitude thresholds, one or more of the threshold may include event duration thresholds. Step 518 may be performed, for example, by liquid ingress event identifier 208.

In step 518, the second threshold TH_T₂ is less than the first threshold TH_T₁. Similarly, the second threshold TH_RH₂ is less than the first threshold TH_RH1. Step 518 allows an additional comparison of the temperature CR and relative humidity CR to be made to further liquid ingress conditions, to reduce the detection of false positive ingress events. Thus, in FIG. 5, a first condition (i.e., CR_{T}>TH_T₁ or CR_{RH}>TH_RH₁ shown in step 510) may be used to identify liquid ingress events. However, using only one condition (i.e., identifying a liquid ingress event when only the temperature CR or the relative humidity CR matches the respective threshold) may lead to false positive ingress event detection. Using a second condition (step 518), where both the temperature CR or the relative humidity CR matches the respective threshold TH_T₂, TH_RH₂ may reduce the detection of false positive ingress events.

If it is determined, at step 518, that both the temperature CR and the relative humidity CR satisfies the conditions of step 518 (such as by liquid ingress event identifier 208), step 518 proceeds to step 512, and steps 512-514 are performed, as described above.

If it is determined, at step 518, that both the temperature CR and the relative humidity CR do not satisfy the conditions of step 518 (such as by liquid ingress event identifier 208), step 518 proceeds to optional step 520.

At optional step 520, the liquid ingress event identifier 208 uses additional sensor data from additional sensor(s) 104 to aid in the identification of liquid ingress events. For example, at optional step 520, it is determined whether the temperature CR is greater than a third temperature threshold (TH_T₃) (i.e., CR_{T}>TH_T₃) and the relative humidity is greater than a third relative humidity threshold (TH_RH₃) (i.e., CR_{RH}>TH_RH₃) and the additional sensor data is greater than a sensor threshold (i.e., .e., Sensor>TH). The thresholds TH_T₃, TH_RH₃ and TH represent predetermined liquid ingress conditions 210. In this example, TH_T₃<TH_T₂ and TH_RH₃<TH_RH₂. The additional sensor data may include, for example, a temperature sensor of the CPU of the electronic device 100 (FIG. 1).

If it is determined, at optional step 520, that the temperature CR, the relative humidity CR and the additional sensor data satisfies the conditions of step 520 (such as by liquid ingress event identifier 208), step 520 proceeds to step 512, and steps 512-514 are performed, as described above.

If it is determined, at step 520, that the temperature CR, the relative humidity CR and the additional sensor data do not satisfy the conditions of step 520 (such as by liquid ingress event identifier 208), optional step 520 proceeds to step 522.

At step 522, no event is detected and step 522 proceeds to step 516. At step 516, the process may be performed again, by proceeding to optional step 500 (or directly to step 504). In other examples, the process may cease once a liquid ingress event is detected and recorded (steps 512 and 514).

In FIG. 5, simple binary thresholds are provided as examples of the predetermined liquid ingress condition(s) 210. It is understood that other more complex conditions may be represented, in the form of ƒ(CR_{T},CR_{RH})≧TH or ƒ(CR_{T},CR_{RH})≦TH, where ƒ(CR_{T}, CR_{RH}) is in general a non-linear function of CR_{T} and CR_{RII}. Such conditions correspond to non-linear decision boundaries on the CR_{T}-CR_{RH} plane, e.g. a circle, and can be learned from empirical data.

As shown by the above discussion, aspects of the liquid ingress event detection outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms. Non-volatile storage media include, for example, optical or magnetic disks, such as any of the storage devices in any computer(s) or the like, such as may be used to implement the aspects shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM, a EPROM and an EEPROM, a FLASH-EPROM, any other memory chip or cartridge. Many of these forms of non-transitory computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

### Appendix: Acronym List

The description above has a large number of acronyms to refer to various devices, messages and system components. Although generally known, use of several of these acronyms is not strictly standardized in the art. For the convenience of the reader, the following list correlates terms to acronyms, as used by way of example in the detailed description above.

CD-ROM—Compact Disk Read Only Memory

CPU—Central Processing Unit

CR—Change Rate

DVD—Digital Video Disk

DVD-ROM—Digital Video Disk Read Only Memory

EPROM—Erasable Programmable Read Only Memory

EEPROM—Electrically Erasable Programmable Read Only Memory

FLASH-EPROM—Flash Erasable Programmable Read Only Memory

LDI—Liquid Damage Indicator

NFC—Near Field Communication

PROM—Programmable Read Only Memory

RAM—Random Access Memory

RF—Radio Frequency

RH—Relative Humidity

ROM—Read Only Memory

USB—Universal Serial Bus

What is claimed is:

1. A method comprising:
synchronously collecting temperature data and moisture data from at least one sensor unit coupled to an electronic device susceptible to liquid damage;
determining, by a processor, a rate of change of each of the temperature data and the moisture data to form respective temperature change rate data and moisture change rate data;
comparing, by the processor, each of the temperature change rate data and the moisture change rate data to at least one predetermined liquid ingress condition;
identifying, by the processor, a liquid ingress event when at least one of the temperature change rate data or the moisture change rate data matches the at least one predetermined liquid ingress condition; and
storing an indication of the identified liquid ingress event.

2. The method according to claim 1, wherein the collecting of the temperature data and the moisture data is performed periodically over a predetermined duty cycle and the steps of determining, comparing, identifying and storing are repeated responsive to the predetermined duty cycle.

3. The method according to claim 1, the method further comprising:
collecting additional sensor data, the additional sensor data including at least one of additional temperature data, barometric pressure data or inertial sensor data; and
at least one of identifying the liquid ingress event or activating collection of the temperature data and the moisture data responsive to the collected additional sensor data.

4. The method according to claim 1, wherein the at least one predetermined liquid ingress condition includes at least one of a temperature change rate threshold, a moisture change rate threshold, a temperature change rate duration value or a moisture change rate duration value.

5. The method according to claim 1, wherein the at least one predetermined liquid ingress condition includes a first condition associated with the temperature change rate and a second condition associated with the moisture change rate, and the identifying of the liquid ingress event includes:
determining whether either the temperature change rate matches the first condition or the moisture change rate matches the second condition to identify the liquid ingress event.

6. The method according to claim 1, wherein the at least one predetermined liquid ingress condition includes a first condition and at least one second condition different from the first condition, and the identifying of the liquid ingress event includes:
determining whether the temperature change rate or the moisture change rate matches the first condition;
determining whether the temperature change rate and the moisture change rate matches the at least one second condition responsive to determining that the temperature change rate or the moisture change rate matches the first condition; and
identifying the liquid ingress event when the temperature change rate and the moisture change rate matches the at least one second condition.

7. The method according to claim 1, wherein the storing of the indication includes storing the indication of the identified liquid ingress event in an embedded element configured to be readable when the electronic device becomes inoperable.

8. A liquid ingress detector of an electronic device susceptible to liquid damage comprising:
a change rate determination unit configured to receive temperature data and moisture data synchronously collected from at least one sensor unit coupled to the electronic device, the change rate determination unit configured to determine a rate of change of each of the temperature data and the moisture data to form respective temperature change rate data and moisture change rate data; and
a liquid ingress event identifier configured to:
compare each of the temperature change rate data and the moisture change rate data to at least one predetermined liquid ingress condition,
identify a liquid ingress event when at least one of the temperature change rate data or the moisture change rate data matches the at least one predetermined liquid ingress condition, and
generate an indication of the identified liquid ingress event.

9. The liquid ingress detector according to claim 8, further comprising at least one additional sensor, wherein the liquid ingress event identifier is further configured to receive sensor data collected from the at least one additional sensor and to match the sensor data to a further predetermined liquid ingress condition to identify the liquid ingress event.

10. The liquid ingress detector according to claim 9, wherein the at least one additional sensor includes at least one of a temperature sensor, a barometric pressure sensor or an inertial sensor.

11. The liquid ingress detector according to claim 8, wherein: the sensor unit is configured to collect the temperature data and the moisture data periodically over a predetermined duty cycle, and the change rate determination unit and the liquid ingress identifier are configured to operate to identify the liquid ingress event based on the predetermined duty cycle.

12. The liquid ingress detector according to claim 11, wherein the liquid ingress detector receives sensor data collected from at least one inertial sensor configured to detect movement of the electronic device, and the liquid ingress detector selects the predetermined duty cycle based on the received sensor data.

13. The liquid ingress detector according to claim 8, further comprising a trigger event detector configured to receive sensor data collected from at least one inertial sensor, wherein the trigger event detector is configured to detect movement of the electronic device based on the received sensor data and to activate the collection of the temperature data and the moisture data by the at least one sensor unit responsive to the detected movement.

14. The liquid ingress detector according to claim 8, wherein the liquid ingress detector is configured to send the indication of the identified liquid ingress event to an embedded element for storage in the embedded element, the embedded element configured to be readable when the electronic device becomes inoperable.

15. An electronic device susceptible to liquid damage comprising:
a liquid ingress detector configured to:
receive temperature data and moisture data synchronously collected from at least one sensor unit coupled to the electronic device,
determine a rate of change of each of the temperature data and the moisture data to form respective temperature change rate data and moisture change rate data,
compare each of the temperature change rate data and the moisture change rate data to at least one predetermined liquid ingress condition, and
identify a liquid ingress event when at least one of the temperature change rate data or the moisture change rate data matches the at least one predetermined liquid ingress condition;
a memory configured to store an indication of the identified liquid ingress event; and
an interface configured to transmit the indication of the identified liquid ingress event.

16. The electronic device according to claim 15, wherein the at least one sensor unit is disposed within a housing of the electronic device and is exposed to an ambient environment external to the electronic device via an aperture in the housing.

17. The electronic device according to claim 15, further comprising at least one additional sensor, wherein the liquid ingress detector uses the at least one additional sensor for at least one of activating collection of the temperature data and the moisture data by the at least one sensor unit or to identify the liquid ingress event.

18. The electronic device according to claim 17, wherein the additional sensor including at least one of a temperature sensor, a barometric pressure sensor or an inertial sensor.

19. The electronic device according to claim 15, wherein the interface includes at least one of a network interface or a near field communication (NFC) interface.

20. The electronic device according to claim 15, wherein the memory includes an embedded element configured to be readable when the electronic device becomes inoperable.
